(19) United States
(12) Patent Application Publication
(10) Pub. No.: US 2023/0316067 A1
(43) Pub. Date: Oct. 5, 2023

(54) METHOD AND SYSTEM FOR A COMPLEX AUTOENCODER UTILIZED FOR OBJECT DISCOVERY

(71) Applicants: Robert Bosch GmbH, Stuttgart (DE); University of Amsterdam, Amsterdam (NL)

(72) Inventors: Maja Rudolph, Madison, WI (US); Sindy Löwe, Amsterdam (NL); Max Welling, Bussum (NL)

(21) Appl. No.: 17/712,860

(22) Filed: Apr. 4, 2022

(51) Int. Cl. G06N 3/08

(52) U.S. Cl. CPC G06N 3/08

(57) ABSTRACT

A computer-implemented method for a machine learning system includes receiving a input image, adding an initial phase to each pixel associated with the input image to create a complex number, sending the complex number to an encoder, wherein the encoder is configured to output a complex-valued latent representation to a decoder, utilizing the decoder, decompose the complex-valued latent representation into a complex-valued output including both a real part and an associated phase, computing a reconstruction error between the input image and the real part of the complex-valued output, wherein the reconstruction error is associated with model parameters associated with the system, and updating and outputting the model parameters associated with the system until a convergence threshold is obtained.

### TECHNICAL FIELD

The present disclosure relates to augmentation and processing of an image (or other inputs) utilizing machine learning.

### BACKGROUND

Object-centric representations form the basis of human perception and enable us to reason about and systematically generalize to new settings. Currently, most machine learning work on object discovery focuses on slot-based approaches, which separate the latent representations of individual objects. While the result may be easily interpretable, it usually requires the design of involved architectures. In contrast to this, we propose a distributed approach to object-centric representations.

### SUMMARY

According to a first embodiment, a computer-implemented method for a machine learning (ML) system includes receiving a input image, adding an initial phase to each pixel associated with the input image to create a complex number, sending the complex number to an encoder, wherein the encoder is configured to output a complex-valued latent representation to a decoder, utilizing the decoder, decompose the complex-valued latent representation into a complex-valued output including both a real part and an associated phase, computing a reconstruction error between the input image and the real part of the complex-valued output, wherein the reconstruction error is associated with model parameters associated with the machine learning system, and updating and outputting the model parameters associated with the machine learning system until a convergence threshold is obtained.

According to a second embodiment, a computer-implemented method for a machine learning system includes receiving a input image, adding an initial phase to each pixel associated with the input image to create a complex number, sending the complex number to an encoder, wherein the encoder is configured to output a complex-valued latent representation to a decoder, utilizing the decoder, decompose the complex-valued latent representation into a complex-valued output including both a real part and an associated phase, computing a reconstruction error between the input image and the real part of the complex-valued output, wherein the reconstruction error is associated with model parameters associated with the machine learning system, and updating and outputting the model parameters associated with the machine learning system until a convergence threshold is obtained, and in response to the convergence threshold being obtained, clustering output phase values associated with the complex-valued output.

According to a third embodiment, a system including a machine-learning network includes an input interface configured to receive input data from a sensor, wherein the sensor includes a camera, a radar, a sonar, or a microphone. The system includes a processor, in communication with the input interface. The processor is programmed to add an initial phase to each pixel associated with the input image to create a complex number, send the complex number to an encoder, wherein the encoder is configured to output a complex-valued latent representation to a decoder, utilizing the decoder, decompose the complex-valued latent representation into a complex-valued output including both a real part and an associated phase, compute a reconstruction error between the input image and the real part of the complex-valued output, wherein the reconstruction error is associated with model parameters associated with the ML system, and update and output the model parameters associated with the ML system until a convergence threshold is obtained.

### BRIEF DESCRIPTION OF THE DRAWINGS

FIG. 1 shows a system 100 for training a neural network.

FIG. 2 shows a computer-implemented method 200 for training a neural network.

FIG. 3 illustrates a flow chart of a hybrid unsupervised semantic segmentation.

FIG. 4 illustrates a flow chart for training a network utilizing the hybrid unsupervised semantic segmentation.

FIG. 5 depicts a schematic diagram of an interaction between computer-controlled machine 10 and control system 12.

FIG. 6 depicts a schematic diagram of the control system of FIG. 1 configured to control a vehicle, which may be a partially autonomous vehicle or a partially autonomous robot.

FIG. 7 depicts a schematic diagram of the control system of FIG. 1 configured to control a manufacturing machine, such as a punch cutter, a cutter or a gun drill, of manufacturing system, such as part of a production line.

FIG. 8 depicts a schematic diagram of the control system of FIG. 1 configured to control a power tool, such as a power drill or driver, that has an at least partially autonomous mode.

FIG. 9 depicts a schematic diagram of the control system of FIG. 1 configured to control an automated personal assistant.

FIG. 10 depicts a schematic diagram of the control system of FIG. 1 configured to control a monitoring system, such as a control access system or a surveillance system.

FIG. 11 depicts a schematic diagram of the control system of FIG. 1 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Neuroscientific theory of temporal coding posits that biological neurons use two mechanisms (firing rate and synchrony) to encode information. A complex Auto-Encoder (CAE) may use complex-valued activations represent two messages: their magnitudes express the presence of a feature, while the relative phase differences between neurons express which features should be bound together to create joint object representations. Such a system may achieve better reconstruction performance than an equivalent real-valued autoencoder on multi-object datasets. Additionally, the system may show that it achieves comparable unsupervised object discovery performance to a Slot Attention model on two datasets, and manages to disentangle objects in a third dataset where Slot Attention fails—all while being faster (e.g., 40-80 times faster) to train.

The system may propose CAE as a model for object discovery that leverages mechanisms inspired by temporal coding to create distributed object-centric representations. The system may start by injecting complex-valued activations into a standard autoencoding architecture. Such a model may make the most efficient use of the additional degree of freedom provided by the complex numbers—and that this, under the right conditions, will result in an object-centric coding scheme. Ultimately, the system may want CAE's complex-valued activations to convey two messages at once: its magnitudes should represent whether a feature is present and its phase values should represent which features ought to be bound together. Using the described mechanisms, after unsupervised training on a multi-object dataset, CAE's output phase values represent different objects in the scene.

To enable an autoencoder to develop object-centric representations, a system and method may be injected with complex-valued activations. The system may translate between the real-valued inputs and outputs used for training the model and the complex-valued activations used for representing object-centric features.

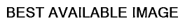

The Complex AutoEncoder (e.g., shown in FIG. 3) may take takes a positive, real valued input image x∈ [symbol] + and associates each pixel with an initial phase φ=0∈ [symbol] to create the complex-valued input x′ to the model: x′=x·exp^{iφ}∈

[symbol]

CAE applies a convolutional encoder f_{enc} and decoder f_{dec} with real-valued parameters θ∈R to this complex-valued input and creates a complex-valued reconstruction \hat{z}:

\hat{z}=f_{dec}(f_{enc}(x′))∈

[symbol]

To make use of existing deep learning frameworks, the system and method may not apply layers on their complex-valued inputs directly. Instead, each layer may extract real-valued components (the real or imaginary part, or the magnitude) from the input and processes them separately, before combining the results into a complex-valued output.

Based on the complex-valued output \hat{z}: of the decoder, the system may create the real-valued reconstruction \hat{x} by applying a 1×1 convolutional layer with a sigmoid activation function fₒᵤₜ on the magnitude of the complex output of the model \hat{x}=fₒᵤₜ (|\hat{z}|)∈ [symbol] ⁺. This allows the model to learn an appropriate scaling and shift of the magnitudes to better match the input values. The model may be trained by comparing this reconstruction to the original input using a mean squared error loss function [symbol] =MSE (x,\hat{x})∈ [symbol] ⁺ and by using the ensuing gradients to update the model parameters.

Finally, the system may use the phase values φ=arg(\hat{z})∈(0,2π) of the complex-valued reconstruction to obtain an object assignment for each pixel. In one example, arg(\hat{z}) describes the angles between the positive real axis and the lines joining the origin and each element in \hat{ }z. In the next section, we will describe the mechanisms that encourage the model to learn phase values that are representative of object identity.

For the CAE to accomplish good object discovery performance, the phases of activations of the same object should be synchronized, while activations induced by different objects should be desynchronized. To achieve this, we need to enable the network to synchronize and desynchronize phases (i.e. to assign the same phases to some activations and different phases to others) and to precisely control phase shifts throughout the network. We achieve this by following three steps for each network layer f_{θ}∈{f_{enc}, f_{dec}} parameterized by θ∈ [symbol] and applied on the input to that layer z∈ [symbol] .

The system may need to encourage the network to synchronize phase values for features that should be bound together. This property is achieved naturally through the use of complex numbers: when adding two complex numbers of opposing phases, they suppress one another or even cancel one another out (a.k.a. destructive interference). Thus, to preserve features, the network needs to align their phase values (a.k.a. constructive interference).

Next, the system may need a mechanism that can desynchronize the phase values. Again, this is achieved naturally through the use of complex numbers: when adding two complex numbers with a phase difference of 90°, for example, the result will lie in between these two numbers and thus be shifted, i.e. desynchronized by 45°. On top of this inherent mechanism, we add a second mechanism that lends the network more control over the precise phase shifts. Specifically, the system may apply each layer separately to the real and imaginary components of its input while sharing the parameters θ to create an intermediate representation ζ:

ζ=f_{θ}(Re(z)+f_{θ}(Im(z)i

[symbol]

For example, applying weights w∈θ and biases b∈θ to a complex-valued input x+yi in a fully-connected layer would result ζ=wx+b+wyi+bi. As a result, this formulation allows the bias b to influence the imaginary component. This enables the model to learn explicit phase shifts throughout the network and to break the symmetry created by the equal phase initialization (Equation (1)).

The system may include a mechanism that enables the model to distinguish inhibitory inputs with aligned phases from excitatory inputs with opposing phases. Given weights w and activations α, in the network formulation above it holds that (−w)·α=w·(−α). However, in the present case they may not be desirable. To enable the model to learn meaningful phase shifts, it needs to be able to distinguish a negative weight from a negative activation, because one has an aligned phase and the other does not. The system may achieve this by taking the absolute value of the activations (−w)·|α|≠w·|(−α)|. Thus, we additionally apply each layer on the magnitude of if its input:

x=f_{θ}(|z|)∈

[symbol]

and add the result to the magnitude of to create the layer's output phase and magnitude:

φ_{z}=arg(ζ)∈

[symbol]

m_{z}=0.5·|ζ|+0.5·χ∈

[symbol]

This addition of the χ term was initially proposed to improve the biological plausibility of a complex-valued model, as it results in a similar output rate modulation by different phase offsets.

The system may propose a new activation function for complex-valued activations to further ensure maximal control of the network over all phase shifts. To create a layer's final output z′, the system may apply a non-linearity on the magnitudes m_{z}, but keep the phases φ_{z} unchanged:

m′_{z}=ReLU(BatchNorm(m_{z}))∈

[symbol]

z′=m′_{z}·exp^{iφz}∈

[symbol]

There are several things to note in this setup. First, m_{z} might be negative as a result of the summation with potentially negative values χ. Nonetheless, it is overall biased towards positive values due to the usage of absolute values throughout each layer. Second, by applying BatchNormalization, the system may ensure that—at least initially—these values become zero-centered and therefore make use of the non-linear part of the ReLU activation function. At the same time, BatchNormalization provides the flexibility to learn to shift and scale these values if appropriate. Finally, the ReLU non-linearity ensures that all values in m′_{z} are positive and thus prevents any phase flips in the output z′.

To use the CAE for object discovery, the system may create pixel-wise segmentation masks by labelling all output phase values through a clustering procedure. Thus, the system may create k cluster assignments for all phase values, where k corresponds to the number of objects in the input plus one for the background. To achieve this, the system may first account for the fact that the phase values of complex numbers with small magnitudes become increasingly random. The system may do so by replacing the phase values of complex numbers whose magnitude m<0.1 with a default value of 0. To account for the circular nature of the phase values, they may be mapped onto a unit circle. This prevents values close to 0 and a from being assigned to different clusters despite representing similar angles. Finally, the system may apply k-means and interpret the resulting cluster assignments for each phase value as the predicted label of the underlying pixel.

Note that, while this approach requires k to be set in advance, CAE itself learns to disentangle the appropriate amount of objects autonomously. Thus, when the number of objects is unknown, the system could potentially devise a different clustering scheme by assessing the relative phase differences between objects instead.

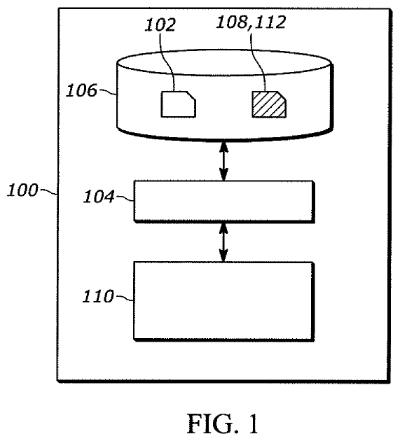

FIG. 1 shows a system 100 for training a neural network. The system 100 may comprise an input interface for accessing training data 192 for the neural network. For example, as illustrated in FIG. 1, the input interface may be constituted by a data storage interface 180 which may access the training data 192 from a data storage 190. For example, the data storage interface 180 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 190 may be an internal data storage of the system 100, such as a hard drive or SSD, but also an external data storage, e.g., a network-accessible data storage.

In some embodiments, the data storage 190 may further comprise a data representation 194 of an untrained version of the neural network which may be accessed by the system 100 from the data storage 190. It will be appreciated, however, that the training data 192 and the data representation 194 of the untrained neural network may also each be accessed from a different data storage, e.g., via a different subsystem of the data storage interface 180. Each subsystem may be of a type as is described above for the data storage interface 180. In other embodiments, the data representation 194 of the untrained neural network may be internally generated by the system 100 on the basis of design parameters for the neural network, and therefore may not explicitly be stored on the data storage 190. The system 100 may further comprise a processor subsystem 160 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 160 may be further configured to iteratively train the neural network using the training data 192. Here, an iteration of the training by the processor subsystem 160 may comprise a forward propagation part and a backward propagation part. The processor subsystem 160 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 196 of the trained neural network, this data may also be referred to as trained model data 196. For example, as also illustrated in FIG. 1, the output interface may be constituted by the data storage interface 180, with said interface being in these embodiments an input/output (“IO”) interface, via which the trained model data 196 may be stored in the data storage 190. For example, the data representation 194 defining the ‘untrained’ neural network may during or after the training be replaced, at least in part by the data representation 196 of the trained neural network, in that the parameters of the neural network, such as weights, hyperparameters and other types of parameters of neural networks, may be adapted to reflect the training on the training data 192. This is also illustrated in FIG. 1 by the reference numerals 194, 196 referring to the same data record on the data storage 190. In other embodiments, the data representation 196 may be stored separately from the data representation 194 defining the ‘untrained’ neural network. In some embodiments, the output interface may be separate from the data storage interface 180, but may in general be of a type as described above for the data storage interface 180.

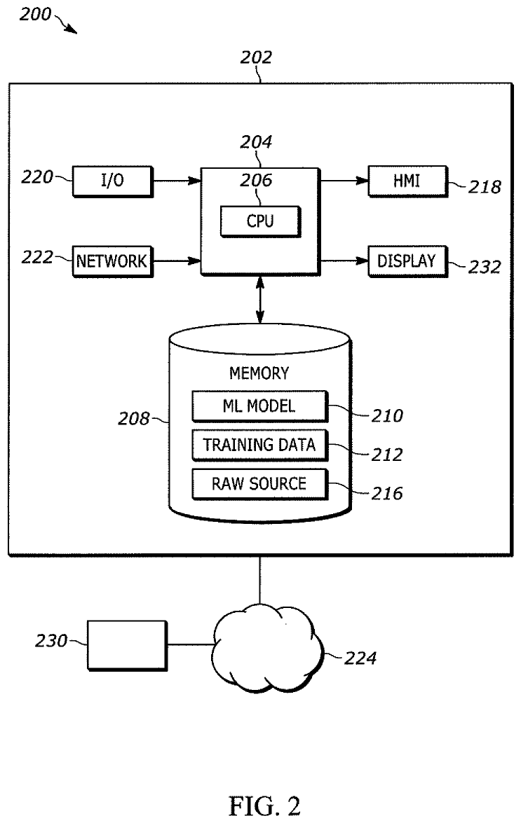

FIG. 2 depicts a data annotation system 200 to implement a system for annotating data. The data annotation system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 215.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 330 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 215. The raw source dataset 215 may include raw or unprocessed sensor data that may be representative of an input dataset for a machine-learning system. The raw source dataset 215 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 215. The raw source data 215 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 215 to identify the presence of the particular features. The machine-learning algorithm 210 may be configured to identify a feature in the raw source data 215 as a predetermined feature (e.g., pedestrian). The raw source data 215 may be derived from a variety of sources. For example, the raw source data 215 may be actual input data collected by a machine-learning system. The raw source data 215 may be machine generated for testing the system. As an example, the raw source data 215 may include raw video images from a camera.

In the example, the machine-learning algorithm 210 may process raw source data 215 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

FIG. 3 illustrates an embodiment of a flowchart as related to robustifying pretrained classifiers. Block 301 represent a complex value image. In such an example, this may include number 3 overliad by a square. At block 303, the system may receive as input a phase value. The system may utilize the real valued input image x∈ [symbol] + and associates each pixel with an initial phase φ=0∈ [symbol] to create the complex-valued input x′ to the model: x′=x·exp^{iφ}∈ [symbol] .

Block 305 may represent an encoder and decoder that form the complex value autoencoder (CAE). The CAE may apply a convolutional encoder f_{enc} and decoder f_{dec} with real-valued parameters θ∈R to this complex-valued input and creates a complex-valued reconstruction \hat{z}:

\hat{z}=f_{dec}(f_{enc}(x′))∈

[symbol]

At block 307, the reconstructed input image may be output from the CAE. At block 309, the output of the phase cluster of each of the phases may be output. Each layer may extract real-valued components (the real or imaginary part, or the magnitude) from the input and processes them separately, before combining the results into a complex-valued output.

In alternative embodiments, the system could initialize the phases with different values. For example, a pixel positional embedding to improve separation of similar objects in different locations. The system may also utilize a different reconstruction loss, such as binary cross-entropy loss or other types of loss. The system may also alter the computation for by applying the weights as described above, however, they may apply biases separately on the resulting magnitude and phase values. Such an embodiment would allow the model to learn explicit phase shifts through the new bias term.

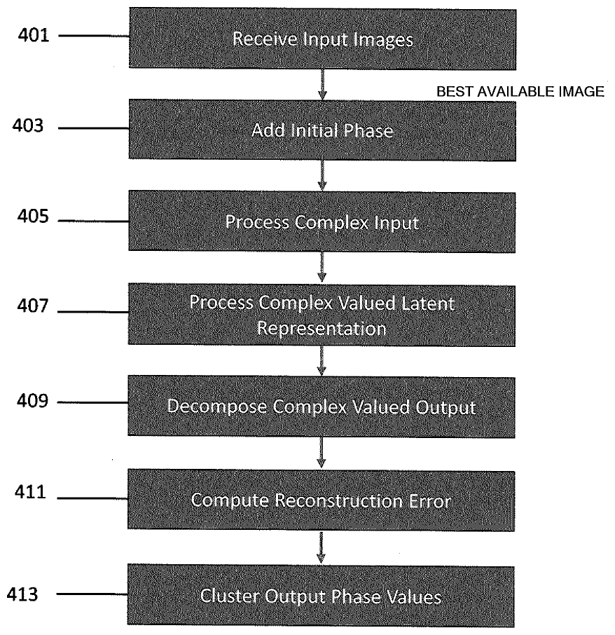

FIG. 4 illustrates an embodiment of a flowchart of the CAE system according to an embodiment. At step 401, the system may receive input images (real valued). The input images may be digital images, audio, video, radar, LiDAR, ultrasonic, motion, thermal images, etc. At step 403, the system may add initial phase (0) to each pixel (each input value (i.e. pixel) is now a complex number). At step 405, the system may process complex input by encoder to obtain complex valued latent representation. At step 407, the system may process complex valued latent representation by decoder to obtain complex valued output. At step 409, the system may decompose complex valued output into real part (needed during training) and into phase (needed for object discovery). At step 411, the system may train the model by computing the reconstruction error between the real input and real output. The system may use such information as training signal to update model parameters (repeat steps 403 through 407) until validation error stops improving. Thus, it may stop until approaching a convergence threshold associated with the machine learning network. The system may cluster output phase values (e.g. with K-means) at step 413. Pixels whose phases are assigned to the same cluster are determined to belong to the same object.

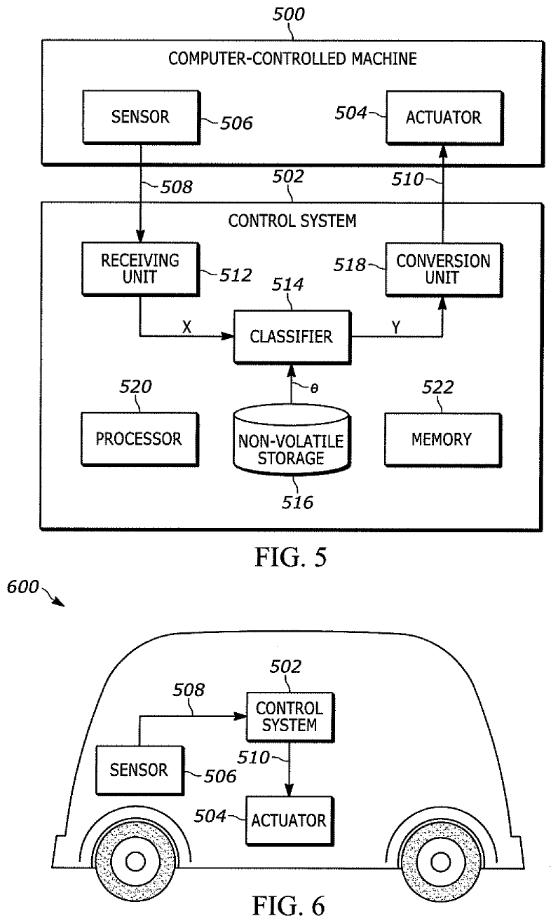

FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

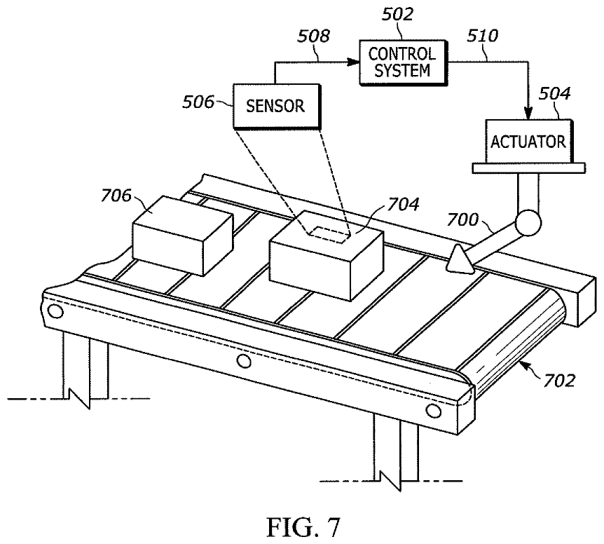

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

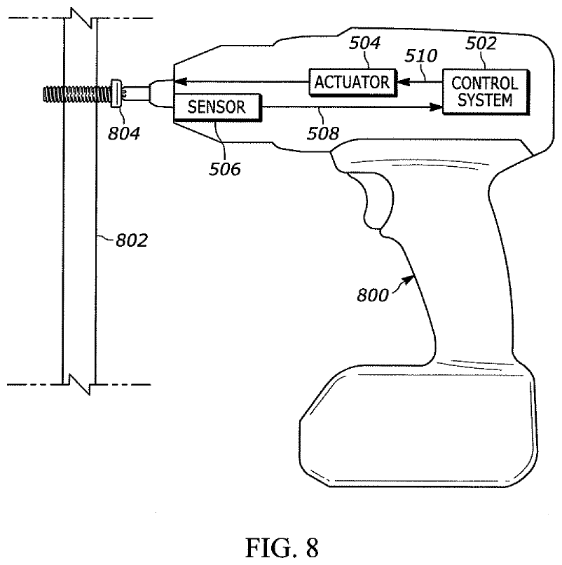

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

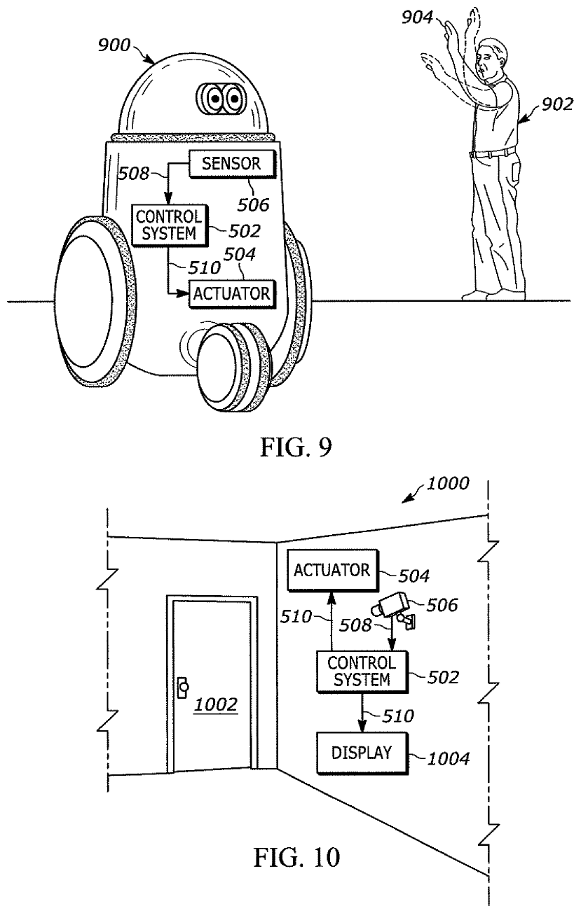

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may identify adversarial perturbations or random perturbations (e.g., bad shadows or lighting) in the video of the environment.

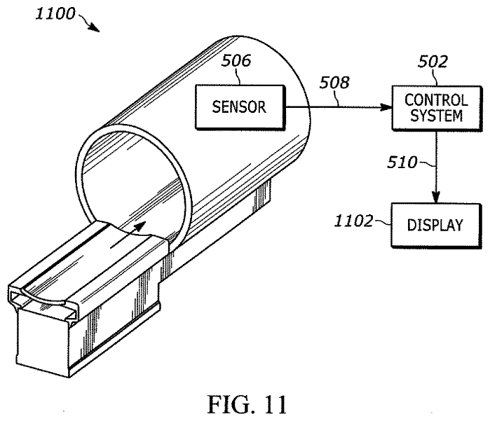

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 302 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. The computer-implemented method for a machine learning (ML) system comprising:
receiving a input image;
adding an initial phase to each pixel associated with the input image to create a complex number;
sending the complex number to an encoder, wherein the encoder is configured to output a complex-valued latent representation to a decoder;
utilizing the decoder, decompose the complex-valued latent representation into a complex-valued output including both a real part and an associated phase;
computing a reconstruction error between the input image and the real part of the complex-valued output, wherein the reconstruction error is associated with model parameters associated with the ML system; and
updating and outputting the model parameters associated with the ML system until a convergence threshold is obtained.

2. The computer-implemented method of claim 1, wherein the method includes the step of applying each layer separately to real and imaginary components associated with the input while sharing the model parameters to create an intermediate representation.

3. The computer-implemented method of claim 1, wherein the method includes the step of distinguishing inhibitory inputs with aligned phases from excitatory inputs with opposing phases.

4. The computer-implemented method of claim 1, wherein the input image is a positive, real-valued input image.

5. The computer-implemented method of claim 1, wherein the method includes initializing the associated phases with different values.

6. The computer-implemented method of claim 1, the encoder is configured to further output a complex-valued latent representation.

7. The computer-implemented method of claim 1, the input image includes image data from a camera, a radar, a sonar, or a microphone.

8. The computer-implemented method for a machine learning (ML) system comprising:
receiving a input image;
adding an initial phase to each pixel associated with the input image to create a complex number;
sending the complex number to an encoder, wherein the encoder is configured to output a complex-valued latent representation to a decoder;
utilizing the decoder, decomposing the complex-valued latent representation into a complex-valued output including both a real part and an associated phase;
computing a reconstruction error between the input image and the real part of the complex-valued output, wherein the reconstruction error is associated with model parameters associated with the ML system;
updating and outputting the model parameters associated with the ML system until a convergence threshold is obtained; and
in response to the convergence threshold being obtained, clustering output phase values associated with the complex-valued output.

9. The computer-implemented method of claim 8, wherein the input image is a positive, real-valued input image.

10. The computer-implemented method of claim 8, wherein the method includes initializing the associated phases with different values.

11. The computer-implemented method of claim 8, wherein the method includes the step of applying each layer separately to real and imaginary components associated with the input while sharing the model parameters to create an intermediate representation.

12. The computer-implemented method of claim 8, wherein the method includes determining the cluster phase values belong to a same object based on pixels whose phases are assigned to a same cluster.

13. The computer-implemented method of claim 8, wherein the input image includes image data from a camera, a radar, a sonar, or a microphone.

14. A system including a machine-learning network, comprising:
an input interface configured to receive input data from a sensor, wherein the sensor includes a camera, a radar, a sonar, or a microphone;
a processor, in communication with the input interface, wherein the processor is programmed to:
add an initial phase to each pixel associated with the input image to create a complex number;
send the complex number to an encoder, wherein the encoder is configured to output a complex-valued latent representation to a decoder;
utilizing the decoder, decompose the complex-valued latent representation into a complex-valued output including both a real part and an associated phase;
compute a reconstruction error between the input image and the real part of the complex-valued output, wherein the reconstruction error is associated with model parameters associated with the ML system; and
update and output the model parameters associated with the ML system until a convergence threshold is obtained.

15. The system of claim 14, wherein the processor is further programmed to, in response to the convergence threshold being obtained, clustering output phase values.

16. The system of claim 15, wherein the processor is further programmed to determine that the cluster phase values belong to a same object based on pixels whose phases are assigned to a same cluster.

17. The system of claim 14, wherein the input data is a positive, real-valued input image.

18. The system of claim 14, wherein the processor is programmed to apply one or more layers separately to real and imaginary components associated with the input data while sharing the model parameters to create an intermediate representation.

19. The system of claim 14, wherein the processor is programmed to determine the cluster phase values belong to a same object based on pixels whose phases are assigned to a same cluster.

20. The system of claim 8, wherein the processor is further programmed to apply biases separately on resulting magnitudes and output phase values.
